(19) United States
(12) Patent Application Publication
(10) Pub. No.: US 2019/0164094 A1
(43) Pub. Date: May 30, 2019

(54) RISK RATING ANALYTICS BASED ON GEOGRAPHIC REGIONS

(71) Applicant: Promontory Financial Group LLC, Washington, DC (US)

(72) Inventor: Daniel J. Ferranti, Washington, DC (US)

(21) Appl. No.: 15/823,170

(22) Filed: Nov. 27, 2017

(51) Int. Cl. G06Q 10/06; G06F 17/30

(52) U.S. Cl. CPC G06Q 10/0635; G06F 17/30654

(57) ABSTRACT

A default risk rating for a geographic region is determined based on a first set of data records extracted from a first set of data sources. Unstructured text description of operational activities associated with the geographic region is received. A second set of data records from a second set of data sources is selected, in which the second set of data sources originate from the geographic region. A subset of the second set of data records is determined based on the unstructured text description of operational activities. The default risk rating is adjusted based on the subset of the second set of data records.

### TECHNICAL FIELD

The present invention relates generally to a method, system, and computer program product for predictive analytics and forecasting. More particularly, the present invention relates to a method, system, and computer program product for performing risk rating analytics based on geographic regions.

### BACKGROUND

Today, organizations around the world are constantly expanding their operations to other geographic regions, often pursing opportunities in new countries. Due to the increase of cross-border transactions and international business arrangements, the organizations are now conducting corporate activities on a global scale, such as launching new products and services in unfamiliar geographic regions. In response, several national governments and international governments established various regulations to govern the organizations' behavior and activities to ensure that the cross-border transactions are legal and ultimate benefit the society.

As such, the organizations need to comply with the rules and regulations as required by several national and international governing bodies. Failure to follow the rules and regulations often leads to corrective and regulatory actions by the governing bodies, which adversely affect the organizations to continue engaging in new business activities. In other words, any disruption to potentially profitable organizational activities, the disruption caused by a regulatory action, can derail an organization's confidence in further expanding its operations to unknown geographic regions. Thus, organizations routinely evaluate any operational risk involved in expanding their operations into new geographic regions.

### SUMMARY OF THE INVENTION

The illustrative embodiments provide a method, system, and computer program product. An aspect of the present invention determines a default risk rating for a geographic region based on a first set of data records extracted from a first set of data sources. The aspect of the present invention receives unstructured text description of operational activities associated with the geographic region. The aspect of the present invention selects a second set of data records from a second set of data sources, the second set of data sources originating from the geographic region. The aspect of the present invention determines a subset of the second set of data records based on the unstructured text description of operational activities. The aspect of the present invention adjusts the default risk rating based on the subset of the second set of data records.

An aspect of the present invention includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

An aspect of the present invention includes a computer program product. The computer program product includes one or more computer-readable storage devices, and program instructions stored on at least one of the one or more storage devices.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example system performing risk rating analytics based on geographic regions in accordance with an illustrative embodiment;

FIG. 4 depicts a block diagram of an example implementation of performing risk rating analytics based on geographic regions in accordance with an illustrative embodiment; and

FIG. 5 depicts a flowchart of an example process for performing risk rating analytics based on geographic regions in accordance with an illustrative embodiment.

### DETAILED DESCRIPTION OF THE EMBODIMENTS

The illustrative embodiments recognize that several business organizations continue to increase their global presence by offering their products and services to newer countries, in an effort to potentially generate more revenue. Although expanding into new geographic regions or countries may present plenty of opportunities, organizations often struggle to navigate through laws and regulations in such geographic regions which may be enforced differently from the existing countries in which the organizations already operate.

For example, consider an organization venturing into a new geographic region to provide its new cryptocurrency transaction services. In the United States, there are only a few laws and regulations that govern the use of cryptocurrency such as Bitcoin, other than tax reporting requirements for gains and losses through cryptocurrency transactions. The new geographic region, however, includes several regulations that require cryptocurrency transactions above a certain amount to be reported to its securities regulatory agency. Unbeknownst to the organization, the new cryptocurrency transaction services without the rigorous reporting mechanisms may prompt the new geographic region's government authorities to sanction the organization under the anti-money laundering (AML) regulations. Accordingly, it can be assumed that the risk of violating AML regulations when dealing with cryptocurrency can be significantly higher in the new geographic region as compared to the United States.

The illustrative embodiments recognize that there are existing solutions that assist an organization to understand the risks involved in conducting business activities in certain geographic regions and/or countries based on the regulations, sanctions, and other types of regulatory actions established by national and international governing bodies. For example, the existing systems may evaluate the risk of sanctions of an organization conducting business in a specific country, based on the AML programs administered by Office of Foreign Assets Control (OFAC) of the U.S. Department of Treasury and the at-risk jurisdictions identified by the Financial Crimes Enforcement Network (FinCEN). In addition, the illustrative embodiments recognize that the existing systems provide a set of ratings which provides the extent of the risk exposed to the organization should it provide its products and services in a geographic region, ranging from low, medium, and high risk.

The illustrative embodiments, however, recognize that the current risk rating systems utilize data sources that are typically adopted on a global scale. For instance, in addition to the above, these data sources may include regulations established by international governing bodies such as Organization for Economic Cooperation and Development (OECD) and World Bank. The existing systems, however, do not take regulations present in local geographic regions into account which may expose an organization to rules and sanctions of such local geographic regions.

The illustrative embodiments further recognize that the current risk rating systems are applied broadly to the extent that they do not consider the business activities, actual and planned, conducted by the organization. For example, an organization heavily engaged in cash transactions with high volume may require strict compliance standards under AML rules and regulations in a local geographic region, as opposed to another organization planning to provide certificate of deposit account products for the customers within the same local geographic region.

Therefore, the illustrative embodiments recognize that there are no existing solutions that determine the level of inherent risk that the organization will be impacted within local geographic regions and countries, especially within the context of the types of operations conducted therein. At best, the existing solutions generate the risk rating for each country, primarily through a weighted scoring system in which the numerical input to the regulation category is manually entered and customized.

The illustrative embodiments recognize that the presently available tools or solutions do not address the needs or provide adequate solutions for these needs. The illustrative embodiments used to describe the invention generally address and solve the above-described problems and other problems related to evaluating operational risks involved in conducting operational activities in a specific geographic region, based on the description of the operational activities, the presence of local geographic rules in the region, and the volume of the operational activities.

An embodiment can be implemented as a software application. The application implementing an embodiment can be configured as a modification of an existing software platform, as a separate application that operates in conjunction with an existing software platform, a standalone application, or some combinations thereof.

In one embodiment, a risk rating assigned to a geographic region, e.g., a country, can be adjusted based on the local rules specific to a country and the description of operational activities conducted by the organization within the country. Natural Language Processing algorithms (NLP) and machine learning algorithms are implemented to identify whether the description of operational activities conducted by the organization applies to one or more rules and regulations associated with the geographic region. In some embodiments, each regulation data in a local geographic region may be assigned with a variable indicative of the magnitude of the risk which contributes to a higher or lower adjusted risk rating for the geographic region. In one embodiment, if the description of operational activities applies to a rule assigned with a high-risk variable, then the previous risk rating is adjusted accordingly to reflect that engaging in the description of operational activities in the geographic region presents a high risk of being regulated and sanctioned.

In one embodiment, a default risk rating for a local geographic region is initially determined based on global data sources. For example, a default risk rating for a country can be determined as “low” as the country was not identified as at-risk jurisdiction identified by the Financial Crimes Enforcement Network (FinCEN). In some embodiments, the risk ratings may be further characterized as numerical values (e.g., 0.0-10.0), text indicators (e.g., “low risk”), or color-coded schemes (e.g., red color indicating high risk). In some embodiments, the default risk rating can be further determined based on other data sources, such as news sources providing information on rules and regulations being enforced in the local geographic region. In one embodiment, the default risk rating can be determined based on assigning a sub-rating based on each rule or regulation issued by a data source (e.g., OECD), then aggregating the sub-ratings to generate the default risk rating. In those embodiments, the sub-rating determined from a first data source may be adjusted with a greater weight factor than the sub-rating determined from a second data source, which results in the regulation issued from the first data source having a greater impact on the default risk rating for the local geographic region.

In one embodiment, input data including the presence of the local rules within the geographic region and the types and volume of business operations offered or otherwise performed by the organization within the geographic region (e.g., all cash transactions but low volume) are received and processed. In some embodiments, each local rule of within the geographic region may be assigned with a sub-rating, and the data source of each local rule is further assigned by a weight factor. In one embodiment, the types and volume of business transactions can be parsed to identify which subset of the local rules within the geographic region are applicable, and only the sub-ratings with the applicable subset of the local rules (and any weight factors based on the data source) are selected for adjusting the default risk rating value.

In one embodiment, the default risk rating of the local geographic region is adjusted specifically to the applicable local rules and the description of business operations of the organization. After the subset of the local rules within the geographic region is selected based on the types and volume of the operational activities, the sub-ratings corresponding to the subset of the local rules are calculated into the default risk rating. In one embodiment, adjusting the default risk rating includes a change of numerical values (e.g., 5.7 to 8.6), text indicators (e.g., “low risk” to “high risk”), or color-coded schemes (e.g., red color indicating high risk to green color indicating low risk). In some embodiments, the adjusted risk rating can be formatted to be displayed on a graphical user interface.

The illustrative embodiments are described with respect to certain types of transactions, regulations, ratings, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

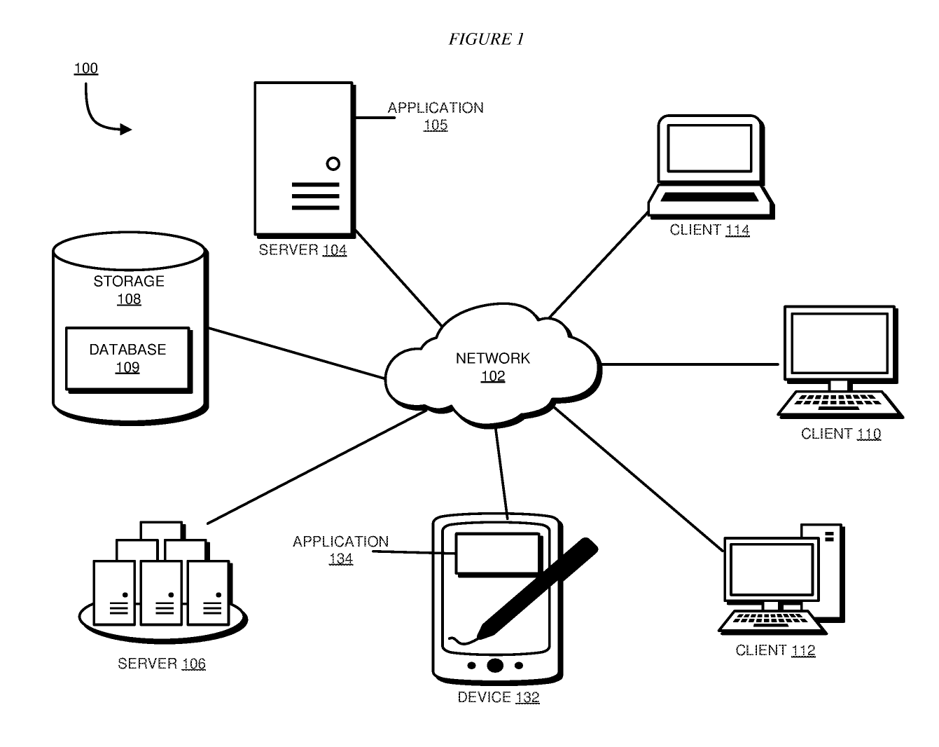

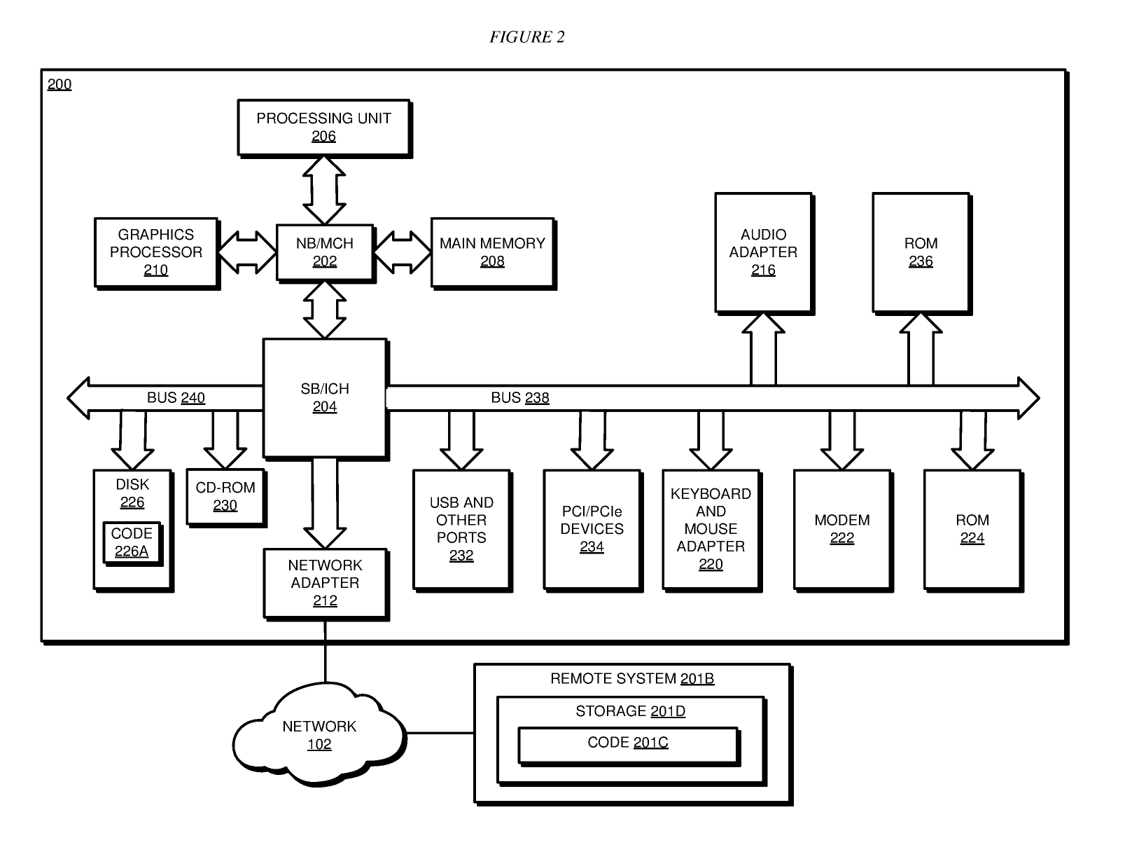

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 105 alone, application 134 alone, or applications 105 and 134 in combination implement an embodiment described herein. Channel data source 107 provides the past period data of the target channel or other channels in a manner described herein.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 and/or application 134 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

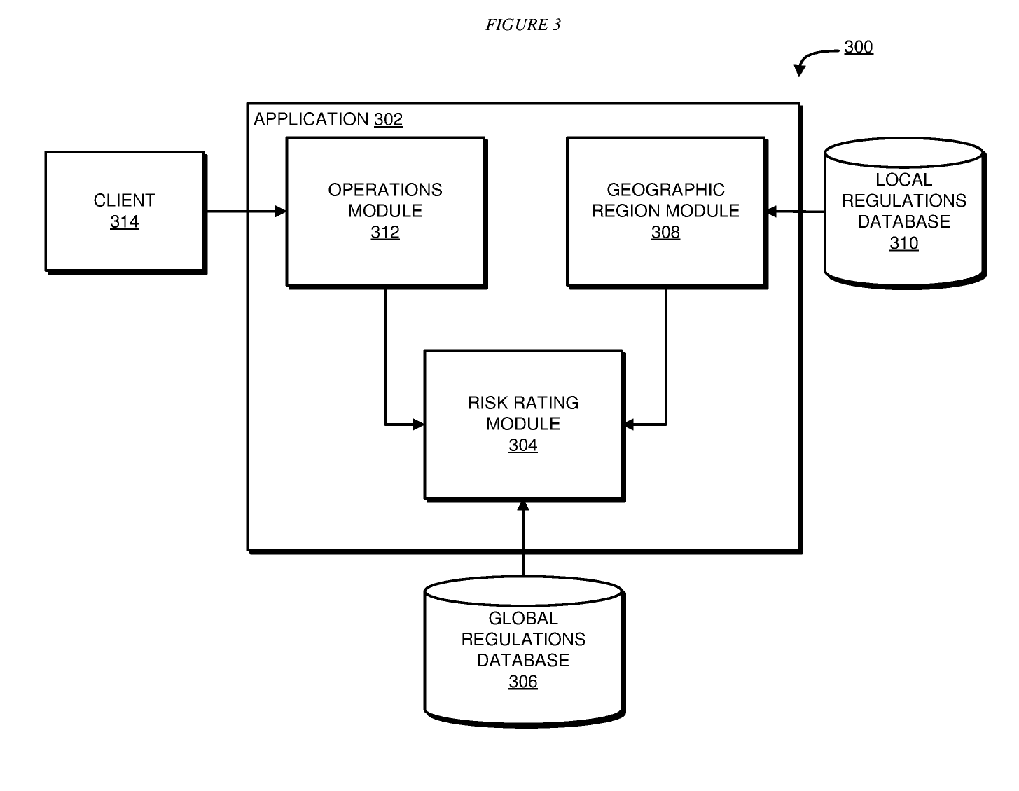

With reference to FIG. 3, this figure depicts a block diagram of an example system performing risk rating analytics based on geographic regions in accordance with an illustrative embodiment. Application 302 is an example of application 105 in FIG. 1. Client 314 is an example of clients 110, 112, and 114 in FIG. 1.

Application 302 includes risk rating module 304, geographic region module 308, and operations module 312. In one embodiment, risk rating module 304 may initially determine a default risk rating for a geographic region. In some embodiments, risk rating module 304 determines the default risk rating for the geographic region based on various global data sources, i.e., data sources not tied to the first geographic region, retrieved from global regulations database 306. In one embodiment, global data sources retrieved from global regulations database 306 may include data records provided by domestic and/or international agencies such as Sanctions programs administered by Office of Foreign Assets Control (OFAC) of the U.S. Department of the Treasury, International Narcotics Control Strategy Report (INCSR) issued by the U.S. State Department, Non-Cooperative Countries and Territories (NCCT) identified by Financial Action Task Force (FATP), and Corruption Perception Index published by Transparency International. In some embodiments, each global data source may include a set of compliance rules and regulations, each of which is assigned with a risk sub-rating. In these embodiments, only the risk sub-ratings associated with the rules and regulations that would apply to the first geographic region are considered in determining the default risk rating.

In another embodiment, risk rating module 304 assigns a first global data source (e.g., OFAC) with a first weight factor to adjust the risk sub-ratings of the first global data source. In one embodiment, risk rating module 304 aggregates the sub-ratings of each global data source to generate the default risk rating. In yet another embodiment, the default risk rating may be further determined based on the severity and the frequency of regulatory enforcement actions administered by the domestic and/or international agencies. For example, if data records provide that United Nations sanctioned a number of organizations operating in the first geographic region for the last five years, risk rating module 304 increases the default risk rating from “medium” to “high.”

In some embodiments, the default risk rating may be further characterized as numerical values (e.g., 0.0-10.0), text indicators (e.g., “low risk”), or color-coded schemes (e.g., red color indicating high risk). In these embodiments, risk rating module 304 may format the initial default risk rating values into a different variable. For example, risk rating module 304 receives a numerical value of 8.7 for the default risk rating then converts the numerical value into color-coded “red.” In some embodiments, the default risk rating can be further determined based on other data sources, such as news sources providing information on rules and regulations being enforced in the local region.

Geographic region module 308 identifies a set of local rules and regulations that were issued from the first geographic region, to wit, the provenance of the set of local rules and regulations may indicate the first geographic region. In one embodiment, geographic region module 308 may determine that a set of local rules and regulations are from the first geographic region based on constructing a database query to retrieve data records from local regulations database 310. In another embodiment, geographic region module 308 may determine that a set of local rules and regulations are from the first geographic region based on parsing the metadata of the data records representative of the local rules and regulations.

In one embodiment, geographic region module 308 assigns a local risk sub-rating to each local rule and regulations within the set of local rules and regulations. In some embodiments, geographic region module 308 may determine that the local rules and regulations issued from the first geographic region do not exist. If so, geographic region module 308 instructs risk rating module 304 to prompt whether default risk rating is to be adjusted based on only the input data generated from operations module 312. In other embodiments, geographic region module 308 instructs risk rating module 304 to reject input data generated from operations module 312 if geographic region module 308 determines that the local rules and regulations issued from the first geographic region do not exist.

Operations module 312 receives input data from client 314 which provides at least one description of operational activities. In some embodiments, description of operational activities may be in different business operations categories such as service operations (e.g., finance, technology), merchandising operations, manufacturing operations, and distribution operations. In one embodiment, the description of operational activities may include the number of the operational activities that are or will be conducted in the first geographic region within a predetermined time period. In another embodiment, the description of operational activities may also include a number of goods being transferred through the operational activities conducted in the first geographic region. For example, a description of operational activities may include a one-time cash transaction in excess of two million dollars for purchasing seventeen cryptocurrency coins in the first geographic region.

In some embodiments, operations module 312 may utilize natural language processing (NLP) algorithms on the description of operational activities provided by client 314. Operations module 312 may execute NLP algorithms to extract content that may be consumed by risk rating module 304. In one embodiment, operations module 312 may parse various forms of the text corpus of the natural language description of operational activities and may output various analysis formats, including part-of-speech tagged text, phrase structure trees, and grammatical relations (typed dependency) format. In some embodiments, operations module 312 can be trained through machine learning via a collection of syntactically annotated data. In one embodiment, operations module 312 may utilize lexicalized parsing to tokenize the natural language description then construct a syntax tree structure of text tokens for the natural language description. In another embodiment, operations module 312 may utilize dependency parsing to identifying grammatical relationships between each of the text tokens in the natural language description. Based on the output from the NLP algorithm, operations module 312 may generate description features that summarize the natural language description of operational activities inputted by client 314.

In one embodiment, risk ratings module 304 is configured to receive the description of operational activities provided by operations module 312 and the set of local rules and regulations of the first geographic region as identified by geographic region module 308. Based on the content in the description of the operational activities, risk ratings module 304 may select a subset of local rules and regulations of the first geographic region applicable to the content and aggregates the local risk sub-ratings assigned to each rule or regulation of the subset of local rules and regulations of the first geographic region. In one embodiment, risk ratings module 304 adjusts the default risk rating based on the aggregated local risk sub-ratings.

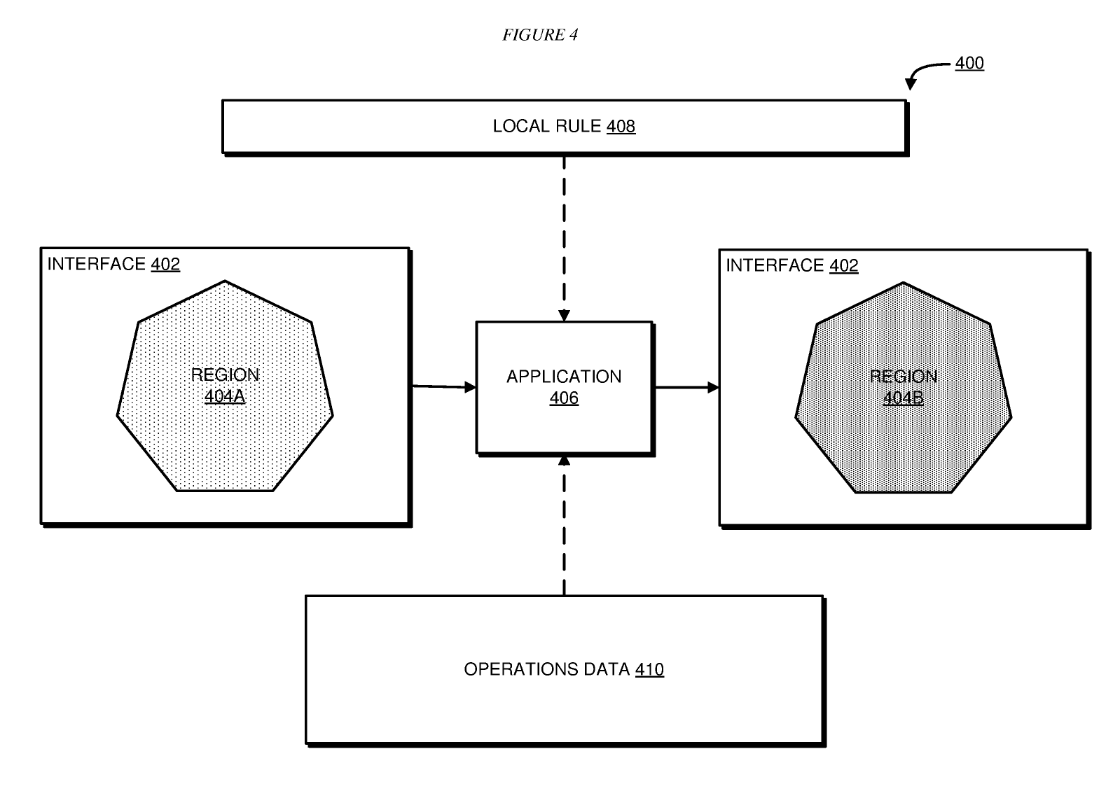

With reference to FIG. 4, this figure depicts a block diagram of an example implementation of performing risk rating analytics based on geographic regions in accordance with an illustrative embodiment. Application 406 is an example of application 105 in FIG. 1 and application 302 in FIG. 3.

In one embodiment, interface 402 provides a graphical representation of region 404A. The graphic pattern in region 404A indicates a default risk rating of “medium” based on the global data source, as initially determined by risk rating module 304 in FIG. 3. Application 406 receives the default risk rating as represented in region 404A. In some embodiments, region 404A can be an interactive interface element, which may provide a list of global data sources along with any risk sub-ratings applied to determine the default risk rating.

Application 406 then receives input data, including local rule 406 and operations data 410. Local rule 406 includes a set of local rules and regulations that were issued from region 404A. Operations data 410 includes input data from client device, via interface 402, which provides at least one description of operational activities expected to be conducted in region 404A by the organization. In response to receiving local rule 406 and operations data 410, application 406 may select a subset of local rules and regulations of the first geographic region applicable to the description of the operational activities. In one embodiment, application 406 may determine an intermediary value based on local rule 406 and operations data 410, in order to adjust the default risk rating assigned to region 404A.

Application 406 adjusts the default risk rating based on local rule 406 and operations data 410. This adjusting of the risk rating value is reflected in region 404B as displayed in interface 402. The adjusted risk rating is depicted as “high” risk in region 404B since application 406 determined that local rule 406 exposed the organization to higher risk of being regulated if it conducts the operational activities as indicated by operations data 410. In some embodiments, region 404B can also be an interactive interface element, which may provide a list of global data sources and local rules and regulations along with any local risk sub-ratings applied to adjust the default risk rating.

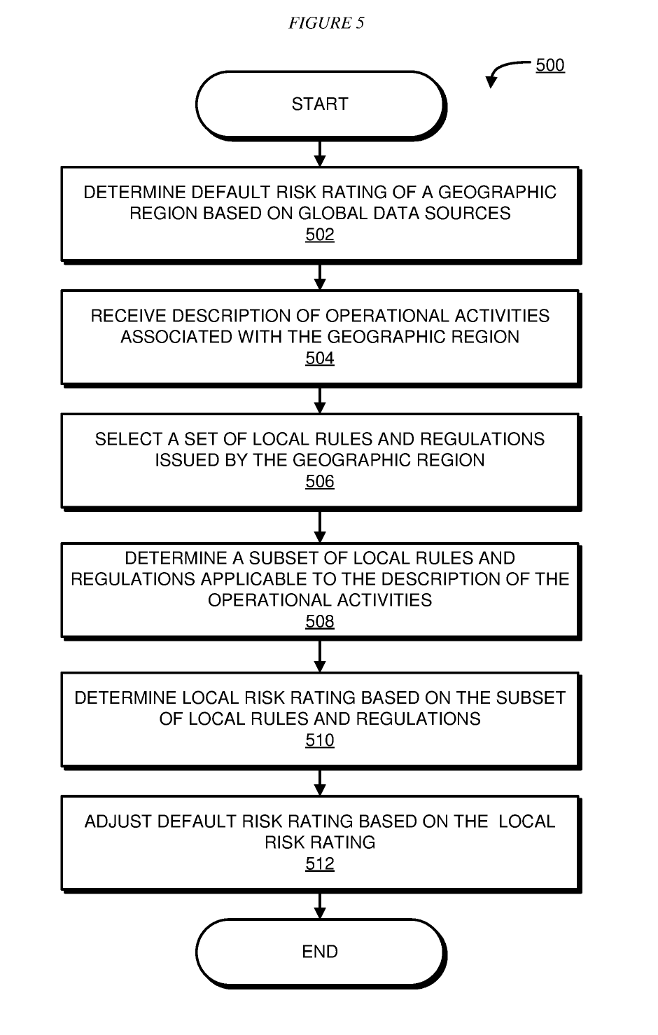

With reference to FIG. 5, this figure depicts a flowchart of an example process for performing risk rating analytics based on geographic regions in accordance with an illustrative embodiment. Process 500 may be implemented in application 302 in FIG. 3.

The application determines default risk rating of a geographic region based on global data sources (block 502). In some embodiments, the application assigns a risk sub-rating for each regulation issued by one of the global data sources, then aggregates the risk sub-ratings for the geographic region. The application receives a description of operational activities associated with the geographic region (block 504). In one embodiment, the description of the operation activities may be processed through NLP algorithms to extract data relevant to adjusting the default risk rating.

The application selects a set of local rules and regulations issued by the geographic region (block 506). The application determines a subset of local rules and regulations applicable to the description of the operational activities (block 508). The application determines a local risk rating based on the subset of local rules and regulations (block 510). The application adjusts default risk rating based on the local risk rating (block 512). In some embodiments, the application may convert the format of the adjusted risk rating to be displayed on a computer graphical user interface, e.g., interface 402 in FIG. 4. Process 500 terminates thereafter.

Thus, a computer implemented method, system or apparatus, and computer program product are provided in the illustrative embodiments for merging two documents that may contain different perspectives and/or bias. Where an embodiment or a portion thereof is described with respect to a type of device, the computer implemented method, system or apparatus, the computer program product, or a portion thereof, are adapted or configured for use with a suitable and comparable manifestation of that type of device.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of determining operational risk specific to a geographic region, the method comprising:
determining, by one or more processors, a default risk rating for a geographic region based on a first set of data records extracted from a first set of data sources;
receiving, by one or more processors, unstructured text description of operational activities associated with the geographic region;
selecting, by one or more processors, a second set of data records from a second set of data sources, the second set of data sources originating from the geographic region;
determining, by one or more processors, a subset of the second set of data records based on the unstructured text description of operational activities; and
adjusting, by one or more processors, the default risk rating based on the subset of the second set of data records.

2. The method according to claim 1, further comprising:
determining, by one or more processors, an intermediary risk rating for the geographic region based on the subset of the second set of data records, wherein the adjusting the default risk rating further includes applying the intermediary risk rating to the default risk rating.

3. The method according to claim 1, further comprising:
converting, by one or more processors, the adjusted risk rating to a different format to be displayed on a graphical user interface.

4. The method according to claim 1, wherein the determining the subset of the second set of data records further comprises:
extracting, by one or more processors, keywords from the unstructured text description of operational activities by applying natural language processing (NLP) algorithms on the unstructured text description of operational activities; and
constructing, by one or more processors, a database query based on the extracted keywords to determine the subset from the second set of data records.

5. The method according to claim 1, wherein the unstructured text description of operational activities includes a number of the operational activities that will be conducted in the first geographic region within a predetermined time period.

6. The method according to claim 4, further comprising:
determining, by one or more processors, that the second set of data records from the second set of data sources does not exist; and
adjusting, by one or more processors, the default risk rating based on parsed content of the unstructured text description of operational activities only.

7. The method according to claim 4, further comprising:
determining that the second set of data records from the second set of data sources does not exist; and
aborting the steps of determining the subset of the second set of data records and adjusting the default risk rating, wherein the default risk rating will remain assigned to the geographic region.

8. A computer program product for determining operational risk specific to a geographic region, the computer program product comprising one or more computer readable storage medium and program instructions stored on at least one of the one or more computer readable storage medium, the program instructions comprising:
program instructions to determine a default risk rating for a geographic region based on a first set of data records extracted from a first set of data sources;
program instructions to receive unstructured text description of operational activities associated with the geographic region;
program instructions to select a second set of data records from a second set of data sources, the second set of data sources originating from the geographic region;
program instructions to determine a subset of the second set of data records based on the unstructured text description of operational activities; and
program instructions to adjust the default risk rating based on the subset of the second set of data records.

9. The computer program product according to claim 8, further comprising:
program instructions to determine an intermediary risk rating for the geographic region based on the subset of the second set of data records, wherein the adjusting the default risk rating further includes applying the intermediary risk rating to the default risk rating.

10. The computer program product according to claim 8, further comprising:
program instructions to convert the adjusted risk rating to a different format to be displayed on a graphical user interface.

11. The computer program product according to claim 8, wherein program instructions to determine the subset of the second set of data records further comprises:
program instructions to extracting keywords from the unstructured text description of operational activities by applying natural language processing (NLP) algorithms on the unstructured text description of operational activities; and
program instructions to construct a database query based on the extracted keywords to determine the subset from the second set of data records.

12. The computer program product according to claim 8, wherein the unstructured text description of operational activities includes a number of the operational activities that will be conducted in the first geographic region within a predetermined time period.

13. The computer program product according to claim 11, further comprising:
program instructions to determine that the second set of data records from the second set of data sources does not exist; and
program instructions to adjust the default risk rating based on parsed content of the unstructured text description of operational activities only.

14. The computer program product according to claim 11, further comprising:
program instructions to determine that the second set of data records from the second set of data sources does not exist; and
program instructions to abort the determination of the subset of the second set of data records and adjustment of the default risk rating, wherein the default risk rating will remain assigned to the geographic region.

15. A computer system for determining operational risk specific to a geographic region, the computer system comprising one or more processors, one or more computer readable memories, one or more computer readable storage medium, and program instructions stored on at least one of the one or more storage medium for execution by at least one of the one or more processors via at least one of the one or more memories, the program instructions comprising:
program instructions to determine a default risk rating for a geographic region based on a first set of data records extracted from a first set of data sources;
program instructions to receive unstructured text description of operational activities associated with the geographic region;
program instructions to select a second set of data records from a second set of data sources, the second set of data sources originating from the geographic region;
program instructions to determine a subset of the second set of data records based on the unstructured text description of operational activities; and
program instructions to adjust the default risk rating based on the subset of the second set of data records.

16. The computer system according to claim 15, further comprising:
program instructions to determine an intermediary risk rating for the geographic region based on the subset of the second set of data records, wherein the adjusting the default risk rating further includes applying the intermediary risk rating to the default risk rating.

17. The computer system according to claim 15, further comprising:
program instructions to convert the adjusted risk rating to a different format to be displayed on a graphical user interface.

18. The computer system according to claim 15, wherein program instructions to determine the subset of the second set of data records further comprises:
program instructions to extracting keywords from the unstructured text description of operational activities by applying natural language processing (NLP) algorithms on the unstructured text description of operational activities; and
program instructions to construct a database query based on the extracted keywords to determine the subset from the second set of data records.

19. The computer system according to claim 15, wherein the wherein the unstructured text description of operational activities includes a number of the operational activities that will be conducted in the first geographic region within a predetermined time period.

20. The computer system according to claim 18, further comprising:
program instructions to determine that the second set of data records from the second set of data sources does not exist; and
program instructions to adjust the default risk rating based on parsed content of the unstructured text description of operational activities only.
